(19) United States
(12) Patent Application Publication
(10) Pub. No.: US 2006/0101093 A1
(43) Pub. Date: May 11, 2006

(54) Processing device and program update method

(75) Inventor: Yasuhiro Nakamura, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/259,101

(22) Filed: Oct. 27, 2005

(30) Foreign Application Priority Data
Nov. 5, 2004 (JP) 2004-321483

(51) Int. Cl. G06F 17/30

(52) U.S. Cl. 707/203

(57) ABSTRACT

A processing device of the invention includes: an insertion unit that has a recording medium, which is set therein in a freely detachable manner and stores a new program for updating at least a target program as an update object; an update module that reads the new program from the recording medium set in the insertion unit and copies the new program in the storage unit to update the target program as the update object to the new program; a deletion module that deletes the new program from the recording medium set in the insertion unit; and a control module. In response to detection of completion of update of the target program as the update object to the new program by the update module, the control module controls the deletion module to delete the new program from the recording medium set in the insertion unit. On completion of update of the target program to the new program stored in the recording medium, the arrangement of the invention deletes the new program from the recording medium without requiring any specific operation of the user to increase the available storage capacity of the recording medium.

### BACKGROUND OF THE INVENTION

1. Field of the Invention

The present invention relates to a processing device that utilizes a recording medium to store a new program or new data and update an existing program or existing data to the new program or the new data and a relevant program update method. More specifically the invention pertains to a technique that deletes a new program or new data stored in a recording medium without requiring any specific operation of a user after update of an existing program or existing data to the new program or the new data, so as to increase the available storage capacity of the recording medium.

2. Description of the Related Art

Card-type storage devices, such as memory cards and IC cards (hereafter referred to as ‘card media’) are adopted as recording media of image data and music data in various processing devices including digital still cameras and portable music players. Some program update methods have been proposed to update a control program in the processing device with such a card medium.

One example of the processing devices is a digital still camera disclosed in Japanese Patent Laid-Open Gazette No. 2002-202866.

The program update method of updating a control program with a card medium is described with reference to a digital still camera as an example of the processing device.

The user first downloads a control program of the latest version via the Internet from a Web window of a manufacturer of a digital still camera to the user's personal computer (PC) and stores the downloaded control program of the latest version in a card medium inserted in a card media drive of the PC. The user then sets the card medium in a digital still camera to update the control program of the previous version stored in a memory of the digital still camera to the control program of the latest version stored in the card medium.

The user naturally desires subsequent application of the card medium used for the update of the control program in the digital still camera as the recording medium of image data. The card medium, however, keeps storage of the control program of the latest version and accordingly has only a limited storage capacity available for storing image data.

Deletion of the control program of the latest version from the card medium increases the available storage capacity of the card medium. For this purpose the user of the digital still camera is demanded to switch over the display from one menu window for update of the control program to another menu window for deletion of the control program and specify the control program to be deleted. Such operations are rather labor-consuming for the users who are unfamiliar with operations of the digital still camera.

This problem arises not only in the digital still cameras but in diversity of other processing devices. The drawback is not characteristic of the update process of control program but is also found in the update process of an application program executed for image processing, for example, rotation of each image and adjustment of the sharpness of each image, as well as in a setting file including data required for execution of the control program or the application program, for example, shutter sound data and frame data to decorate the rim of each image.

### SUMMARY OF THE INVENTION

The object of the invention is thus to eliminate the drawback of the prior art technique and to provide a technique applied to a processing device, which utilizes a recording medium storing a new program to update an existing program stored in the processing device to the new program, to delete the new program from the recording medium without requiring any specific operation of the user and thereby increase the available storage capacity of the recording medium.

In order to attain at least part of the above and the other related objects, the present invention is directed to a first processing device that works according to programs stored in a storage unit. The first processing device includes: an insertion unit that has a recording medium, which is set therein in a freely detachable manner and stores a new program for updating at least a target program as an update object among the stored programs; an update module that reads the new program from the recording medium set in the insertion unit and copies the new program in the storage unit to update the target program as the update object to the new program; a deletion module that deletes the new program from the recording medium set in the insertion unit; and a control module.

In response to detection of completion of update of the target program as the update object to the new program by the update module, the control module controls the deletion module to delete the new program from the recording medium set in the insertion unit.

The new program is deleted from the recording medium set in the processing device, in response to detection of completion of update of the target program as the update object. Such deletion desirably restores the storage capacity of the recording medium used for update of the target program as the update object and increases the available storage capacity of the recording medium.

This arrangement does not require any specification operation of the user after completion of update of the target program as the update object but automatically deletes the new program from the recording medium to increase the available storage capacity of the recording medium.

The present invention is also directed to a second processing device that works according to a program executed based on setting files stored in a storage unit. The second processing device includes: an insertion unit that has a recording medium, which is set therein in a freely detachable manner and stores a new setting file for updating at least a target setting file as an update object among the stored setting files; an update module that reads the new setting file from the recording medium set in the insertion unit and copies the new setting file in the storage unit to update the target setting file as the update object to the new setting file; a deletion module that deletes the new setting file from the recording medium set in the insertion unit; and a control module.

In response to detection of completion of update of the target setting file as the update object to the new setting file by the update module, the control module controls the deletion module to delete the new setting file from the recording medium set in the insertion unit.

The new setting file is deleted from the recording medium set in the processing device, in response to detection of completion of update of the target setting file as the update object. Such deletion desirably restores the storage capacity of the recording medium used for update of the target setting file as the update object and increases the available storage capacity of the recording medium.

This arrangement does not require any specification operation of the user after completion of update of the target setting file as the update object but automatically deletes the new setting file from the recording medium to increase the available storage capacity of the recording medium.

In either of the first processing device and the second processing device of the invention, one preferable example of the recording medium is a card-type storage device.

Various card-type storage devices, for example, CompactFlash (registered trademark), SmartMedia (registered trademark), SD (Secure Digital) memory cards, memory sticks, MMCs (Multimedia Card), xD picture cards, and other memory cards and IC cards are generally used in diverse processing devices as media for storing files generated by application programs.

The technique of the invention deletes the new program or the new setting file from the card-type storage device set in the processing device, in response to detection of completion of update of the target program or the target setting file as the update object. Such deletion desirably restores the storage capacity of the card-type storage device used for update of the target program or the target setting file as the update object and increases the available storage capacity of the card-type storage device. This arrangement desirably enables storage of large-volume files in subsequent use of the card-type storage device in the processing device as the medium for storage of files generated by an application program.

The present invention is not restricted to the processing devices, but is also actualized by diversity of other applications, for example, a program update method, a computer program that is used to attain the arrangement of the processing device or the program update method to update a program, a recording medium in which such a computer program is recorded, and a data signal that includes such a computer program and is embodied in a carrier wave.

In the applications of the invention as the computer program and the recording medium in which the computer program is recorded, the invention may be given as a whole program to control the processing device or as a partial program to exert only the characteristic functions of the invention. Available examples of the recording medium include memory cards, IC cards, punched cards, prints with barcodes or other codes printed thereon, internal storage devices (memories like RAMs and ROMs) and external storage devices of the computer, and diversity of other computer readable media.

### BRIEF DESCRIPTION OF THE DRAWINGS

FIG. 1 schematically illustrates the general configuration of a digital still camera in one embodiment of the invention; and

FIG. 2 is a flowchart showing a control program update routine executed by an update control module in the digital camera of FIG. 1.

### DESCRIPTION OF THE PREFERRED EMBODIMENTS

One mode of carrying out the invention is described below as a preferred embodiment in the following sequence:

A. Embodiment

A1. General Configuration of Digital Still Camera

A2. Detailed Procedure of Control Program File Update Process

A3. Effects of Embodiment

B. Modifications

A. Embodiment

A1. General Configuration of Digital Still Camera

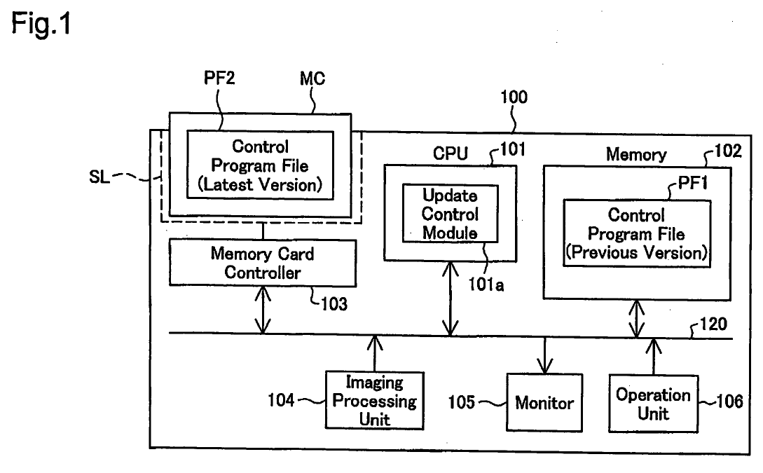

FIG. 1 schematically illustrates the general configuration of a digital still camera 100 in one embodiment of the invention.

The digital still camera 100 includes, as main components, a CPU 101, a memory 102, a memory card controller 103, an imaging processing unit 104, a monitor 105, and an operation unit 106, which are interconnected via an internal bus 120. The digital still camera 100 also has a memory card slot SL for insertion of a memory card MC.

The memory card controller 103 functions to read out image data stored in the form of a file (hereafter referred to as ‘image file’) and a control program stored in the form of a file (hereafter referred to as ‘control program file’) from the memory card MC inserted in the memory card slot SL, to write these files into the memory card MC, and to delete these files from the memory card MC.

The imaging processing unit 104 takes an image, converts an analog signal representing the taken image into a digital signal, and outputs the digital signal. The monitor 105 works to display each image expressed by image data generated in response to the digital signal output from the imaging processing unit 104, each image expressed by the image file read from the memory card MC by the memory card controller 103, and a menu window to allow the user to set image taking conditions and a frame to be added to each image.

The operation unit 106 transmits the user's instruction to a main control module and an update control module 101a (discussed below).

The memory 102 stores a control program file PF1, and the CPU 101 executes the control program file PF1 to function as the main control module. The main control module controls the respective components of the digital still camera 100 in response to the user's instruction received from the operation unit 106, so as to generate image data in response to the digital signal output from the imaging processing unit 104 and store the generated image data as an image file in the memory card MC.

The memory 102 also stores an application program executed to update the control program file, and the CPU 101 executes the application program to function as the update control module 101a.

The update control module 101a opens a menu window for updating the control program file on the monitor 105.

The update control module 101a in the digital still camera 100 of the embodiment corresponds to the control module of the invention. The memory card controller 103 of the embodiment is equivalent to the update module and the deletion module of the invention. The memory card slot SL corresponds to the insertion unit of the invention.

A2. Detailed Procedure of Control Program File Update Process

In order to update the control program file PF1 of the previous version stored in the memory 102 shown in FIG. 1, the user downloads a control program file PF2 of the latest version via the Internet from a Web window of a manufacturer of the digital still camera 100 to the user's PC (not shown) and stores the downloaded control program file PF2 of the latest version in the memory card MC inserted in a memory card drive of the PC. The user takes the memory card MC out of the PC and inserts the memory card MC in the memory card slot SL of the digital still camera 100 as shown in FIG. 1.

The user manipulates the operation unit 106 on the menu window open on the monitor 105 for update of the control program file to give an instruction of updating the control program file PF1 to the digital still camera 100. The update control module 101a of the digital still camera 100 receives the user's instruction of updating the control program file PF1 from the operation unit 106 and starts a control program file update process.

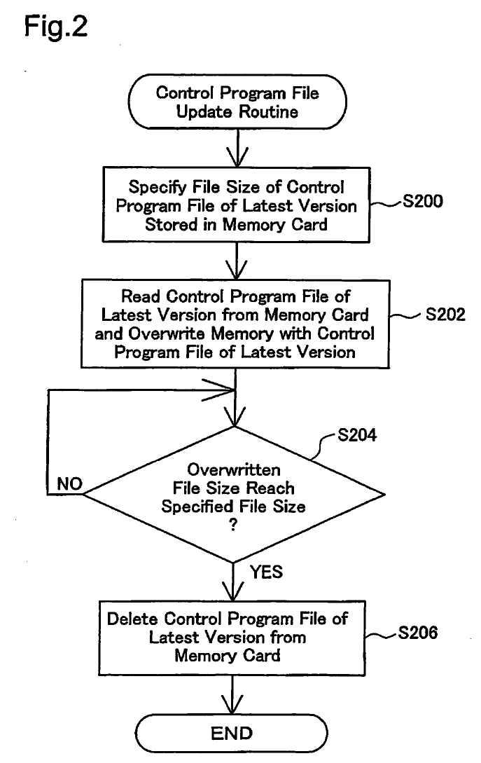

FIG. 2 is a flowchart showing the control program file update process executed by the update control module 101a.

In the control program file update process of FIG. 2, the update control module 101a shown in FIG. 1 first controls the memory card controller 103 to specify the file size of the control program file PF2 of the latest version stored in the memory card MC set in the memory card slot SL and store the specified file size into the memory 102 (step S200).

The update control module 101a then controls the memory card controller 103 to read the control program file PF2 of the latest version from the memory card MC and overwrite the control program file PF1 of the previous version stored in the memory 102 with the control program file PF2 of the latest version (step S202).

The update control module 101a determines whether the overwritten file size reaches the specified file size stored in the memory 102 at step S200 while overwriting to the control program file PF2 of the latest version (step S204).

When the overwritten file size reaches the specified file size, the update control module 101a determines that the control program file PF1 of the previous version has completely been overwritten with and updated to the control program file PF2 of the latest version. The update control module 101a then controls the memory card controller 103 to delete the control program file PF2 of the latest version from the memory card MC (step S206).

This control program file update process updates the control program file PF1 of the previous version to the control program file PF2 of the latest version, while deleting the control program file PF2 of the latest version from the memory card MC to increase the available storage capacity of the memory card MC.

A3. Effects of Embodiment

As described above, the update control module 101a of the digital still camera 100 determines whether the overwritten file size reaches the specified file size, while overwriting the control program file PF1 of the previous version stored in the memory 102 with the control program file PF2 of the latest version read from the memory card MC. The update control module 101a thus detects completion of update of the control program file PF1 of the previous version.

The update control module 101a deletes the control program file PF2 of the latest version from the memory card MC, in response to detection of completion of the update of the control program file PF1 of the previous version. Such deletion desirably restores the storage capacity of the memory card MC used for update of the control program file PF1 of the previous version and increases the available storage capacity of the memory card MC.

The prior art technique requires the user to switch over the display from a menu window for update of the control program to another menu window for deletion of the control program and specify the control program of the latest version to be deleted. The technique of the invention, on the other hand, simply requires the user to give the instruction of updating the control program file PF1 of the previous version in the menu window for update of the control program file. This instruction deletes the control program file PF2 of the latest version stored in the memory card MC and increases the available storage capacity of the memory card MC.

B. Modifications

The embodiment discussed above is to be considered in all aspects as illustrative and not restrictive. There may be many modifications, changes, and alterations without departing from the scope or spirit of the main characteristics of the present invention. Some examples of possible modification are given below.

B1. Modified Example 1

The embodiment regards update of the control program file. The technique of the invention is, however, not restricted to update of the control program file but is also applicable to update of a setting file including data required for execution of a control program or an application program, for example, shutter sound data, frame data, and data (skin data) relating to the layout and the design of various application windows.

In this case, in response to detection of completion of update of an existing setting file, a setting file of the latest version is deleted from a card medium without the user's specific operation to increase the available storage capacity of the card medium.

B2. Modified Example 2

The procedure of the embodiment determines whether the overwritten file size reaches the specified file size to detect completion of the update of the control program file PF1 of the previous version to the control program file PF2 of the latest version. This is, however, not restrictive in any sense. For example, when the control program file includes a code EOF (End of File) representing a file end, a modified procedure may determine whether the code EOF has been written in the memory of the processing device to detect completion of the update of the control program file.

B3. Modified Example 3

The embodiment regards application of the program update technique to the digital still camera 100 as the processing device. The processing device of the invention is, however, not restricted to the digital still camera but may be any of portable music players, cell phones, digital video cameras, TV receivers with built-in projectors, and diversity of other devices that utilize card media to update control programs.

In any of these processing devices, in response to detection of completion of update of an existing program file or setting file, a program file or setting file of the latest version is deleted from a card medium without the user's specific operation to increase the available storage capacity of the card medium.

B4. Modified Example 4

The procedure of the embodiment deletes the control program file PF2 of the latest version stored in the memory card MC, on completion of update of the control program file PF1 of the previous version to the control program file PF2 of the latest version. One possible modification may format the memory card MC, instead of deleting the control program file PF2 of the latest version.

The formatting automatically deletes the control program file PF2 of the latest version from the memory card MC. This arrangement also deletes the control program file PF2 of the latest version without the user's special operation to increase the available storage capacity of the memory card MC.

All changes within the meaning and range of equivalency of the claims are intended to be embraced therein. The scope and spirit of the present invention are indicated by the appended claims, rather than by the foregoing description.

Finally, the present application claims the priority based on Japanese Patent Application No. 2004-321483 filed on Nov. 11, 2004, which is herein incorporated by reference.

What is claimed is:

1. A processing device that works according to programs stored in a storage unit, the processing device comprising:
an insertion unit that has a recording medium, which is set therein in a freely detachable manner and stores a new program for updating at least a target program as an update object among the stored programs;
an update module that reads the new program from the recording medium set in the insertion unit and copies the new program in the storage unit to update the target program as the update object to the new program;
a deletion module that deletes the new program from the recording medium set in the insertion unit; and
a control module,
in response to detection of completion of update of the target program as the update object to the new program by the update module, the control module controlling the deletion module to delete the new program from the recording medium set in the insertion unit.

2. A processing device that works according to a program executed based on setting files stored in a storage unit, the processing device comprising:
an insertion unit that has a recording medium, which is set therein in a freely detachable manner and stores a new setting file for updating at least a target setting file as an update object among the stored setting files;
an update module that reads the new setting file from the recording medium set in the insertion unit and copies the new setting file in the storage unit to update the target setting file as the update object to the new setting file;
a deletion module that deletes the new setting file from the recording medium set in the insertion unit; and
a control module,
in response to detection of completion of update of the target setting file as the update object to the new setting file by the update module, the control module controlling the deletion module to delete the new setting file from the recording medium set in the insertion unit.

3. A processing device in accordance with claim 1, wherein the storage medium is a card-type storage device.

4. A processing device in accordance with claim 2, wherein the storage medium is a card-type storage device.

5. A program update method that is applied to a processing device working according to programs stored in a storage unit, the program update method utilizing a recording medium, which stores a new program for updating at least a target program as an update object among the stored programs, to update the target program as the update object, the program update method comprising the steps of
(a) setting the recording medium in the processing device;
(b) reading the new program from the recording medium set in the step (a) and copying the new program in the storage unit to update the target program as the update object to the new program;
(c) detecting completion of update of the target program as the update object; and
(d) in response to detection of completion of update of the target program as the update object to the new program, deleting the new program from the recording medium set in the step (a).

6. A computer program product that is applied to a computer working according to programs stored in a storage unit, the computer program product utilizing a recording medium, which stores a new program for updating at least a target program as an update object among the stored programs, to update the target program as the update object,
the computer program product comprising:
a first program code of reading the new program from the recording medium set in the computer and copying the new program in the storage unit to update the target program as the update object to the new program;
a second program code of detecting completion of update of the target program as the update object;
a third program code of, in response to detection of completion of update of the target program as the update object to the new program, deleting the new program from the recording medium set in the computer; and
a computer readable medium that stores the first to third program codes.
